(19) United States
(12) Patent Application Publication
(10) Pub. No.: US 2015/0227975 A1
(43) Pub. Date: Aug. 13, 2015

(54) METHODS AND SYSTEMS FOR PROVIDING CONSUMPTION BASED COUPONS

(71) Applicants: Zulfiqar N. Momin, Sugar Land, TX (US); Ahmed Moledina, Austin, TX (US)

(72) Inventors: Zulfiqar N. Momin, Sugar Land, TX (US); Ahmed Moledina, Austin, TX (US)

(73) Assignee: FUELSIGNAL, Austin, TX (US)

(21) Appl. No.: 14/610,368

(22) Filed: Jan. 30, 2015

Related U.S. Application Data
(60) Provisional application No. 61/937,056, filed on Feb. 7, 2014.

(51) Int. Cl. G06Q 30/02

(52) U.S. Cl. CPC G06Q 30/0259; G06Q 30/0207

(57) ABSTRACT

Embodiments disclosed herein provide systems and methods for a retailer to attract consumers to a retailer's location over other retailer's location by transmitting coupons that are based on the consumer's fuel consumption to visit the retailer. In embodiments, the consumer's fuel consumption may be based on a plurality of factors, and as the required fuel consumption to visit the retailer increases the discount associated with a coupon may increase, and as the consumer's fuel consumption decreases the coupon's discount may decrease.

### CROSS-REFERENCE TO RELATED APPLICATIONS

This application claims a benefit of priority under 35 U.S.C. §119 to Provisional Application No. 61/937,056 filed on Feb. 7, 2014, which is fully incorporated herein by reference in its entirety.

### BACKGROUND INFORMATION

1. Field of the Disclosure

Examples of the present disclosure relate to techniques for communicating coupons. More particularly, embodiments are related to communicating coupons with discounts based on a travel distance or fuel consumption.

2. Background

Every year, coupons are distributed to consumers in supermarkets, retail stores, the internet, etc. Coupons and other offerings give both current and prospective consumers a reason to choose a specific retailer over competitors. Retailers use coupons to increase customer traffic, obtain new customers to visit the retailer, increase sales, increase customer loyalty, etc. However, conventional coupons include fixed promotion or discount for a specific item, and do not vary from consumer to consumer. For example, a conventional coupon may be for ten cents of a gallon of gas.

Consumers repeatedly purchase the same good and/or services, often at the same retailer during the same time of day, week, or month. For example, a consumer may refuel their vehicle every other week, purchase groceries on Mondays, purchase lunch at noon, etc. If the consumers wish to purchase these items more cheaply, the consumers are forced to actively search for coupons associated with the specific retailer at a time when the consumer desires to purchase the good and/or service. Consumers may be open to purchasing similar goods or purchasing the goods at different retailers, but these consumers may not be aware of the similar goods or different retailers.

Furthermore, conventional coupons can only be applied to a single retailer. Thus, opportunities for coupons for cross-selling goods and/or services among different retailers are missed.

More recently, location based coupons have become prevalent. Using current location based coupons; a coupon may be transmitted to a consumer when the consumer is physically located at the retailer. However, retailers using current location based coupons do not attract new consumers because a consumer must be physically present at the retailer to receive the location based coupon. Thus, any consumer must be actually located at the retailer to redeem the coupon.

Accordingly, needs exists for more efficient and effective location based coupons, wherein the coupon varies based on the distance from the consumer to the retailers or fuel consumption for the consumer to visit the retailer, while tracking the redemption of the coupons.

### SUMMARY

Embodiments disclosed herein provide systems and methods for a retailer to attract consumers to the retailer's location over another retailer's location by transmitting coupons, points, rewards, promotions, discounts, loyalty programs, etc. (referred to hereinafter collectively and individually as “coupons”). The coupons may be based on the consumer's fuel consumption to visit a promotion retailer and/or the distance between the consumer and the promotion retailer. The coupons may also include discounts found in conventional coupons.

In embodiments, the consumer's fuel consumption may be based on a Mile Per Gallon (MPG) calculation and/or a distance from the consumer to the promotion retailer. As the consumer's fuel consumption to visit the promotion retailer increases, a discount that may be redeemed at a gas retailer within a coupon may increase, and as the consumer's fuel consumption decreases the discount that may be redeemed at the gas retailer may decrease. The coupon may include a conventional coupon for goods and/or services carried by the promotion retailer, and the mileage based reimbursement that may be redeemed at the gas retailer.

In embodiments, the promotion or discount within a coupon may be based on a consumer's location when a coupon is transmitted to the consumer, the location of the promotion retailer, vehicle fuel consumption data, weather conditions affecting fuel consumption, and/or the consumer's driving habits, wherein the consumer's driving habits may include attributes associated with the consumer's driving that may vary the fuel consumption used or routes that the consumer takes.

In embodiments, the coupon may include a promotion for goods and/or services carried by a promotion retailer and a fuel consumption based coupon that can be redeemed at a gas retailer. Responsive to the consumer traveling to the promotion retailer to purchase goods or services, the consumer may be rewarded with the fuel consumption based coupon for goods and/or services offered by the gas retailer. Thus, the reimbursement within the fuel consumption based coupon may be activated in response to the consumer travelling to the promotion retailer and/or purchasing goods and/or services carried by the promotion retailer.

In embodiments, the coupons may be configured to be transmitted to a client computing device associated with the consumer based on the consumer's weekly habits or purchasing history.

In embodiments, the coupons may be transmitted to the consumer based on the location of the consumer, the location of the promotion retailer, setting preferences associated with the consumer, purchasing history associated with the consumer, and/or driving routes associated with the consumer. The setting preferences may be set by default or entered by the consumer, and may be associated with different categories of coupons, discount requirements from specific retailers based on time, location, season, weather, day, months, etc.

In embodiments, the coupons may include a cash reimbursement, a monetary discount, and/or a fuel rewards credit (referred to hereinafter individually and collectively as “discounts”) which may be redeemed at the gas retailer when the consumer purchases goods and/or services at the promotion retailer. Furthermore, the fuel consumption based discounts may be accumulated, such that over a time period the consumer may receive a plurality of discounts that may be redeemed at the gas retailer, wherein the plurality of fuel consumption based discounts may be from a plurality of promotion retailers.

In embodiments, the coupons may include a first promotion, a second promotion, and a third promotion, wherein the first promotion may be for being physically located at the promotion retailer, the second promotion may be for purchasing goods and/or services at the promotion retailer, and the third promotion may be a fuel consumption based discount which is activated based on the first and/or second promotion, wherein the third promotion may be redeemed at the gas retailer.

In embodiments, the coupons may be associated with a group mileage reimbursement, wherein if a certain number of consumers visit the promotion retailer and purchases goods and/or services, each consumer purchasing goods and/or services may receive the higher group mileage promotion that may be redeemed at the gas retailer and/or a discount from a promotion retailer. In embodiments, a processor may be configured to track the mileage and automatically calculate the mileage without any user interaction. The mileage may be automatically tracked when the user is in the vehicle, and the user may receive voice activated coupons at desired locations.

In embodiments, the coupons may also be associated with a consumer's social networks. Using the consumer's social network on at least one social networking platform, the coupons may be pushed to other consumer's within the consumer's social network that are in close proximity to the consumer. By automatically pushing the coupon to other consumers that are within the consumer's social network and in close proximity to the consumer, more consumers may be driven to the promotion retailer.

Furthermore, in embodiments, responsive to the consumer performing actions associated with the coupons on at least one social networking platform, the distance or fuel consumption based discount or reimbursement may increase. For example, if the consumer forwards, retweets, likes, shares, comments on, etc. the coupon on a social networking platform, then the discount associated with the coupon may increase.

In other embodiments, the discount may increase if the consumer performs actions associated with the coupons on multiple social networking platforms. For example, the discount may increase if the consumer forwards or retweets the coupon on a first social networking platform and comments on the coupon on a second social networking platform.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts an embodiment of one topology 100 attracting consumers to retailers.

FIG. 2 depicts an embodiment of a method for transmitting coupons with a promotion based on fuel consumption.

FIG. 3 depicts a method for transmitting coupons with a promotion based on fuel consumption.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments disclosed herein provide systems and methods for a promotion retailer to attract consumers to a retailer's location over other retailer's location by transmitting coupons. The transmitted coupons may include fuel consumption based discounts. The consumer's fuel consumption may be based on a plurality of factors, and as the amount of fuel to visit the retailer increases the discount associated with a coupon may increase, and as the consumer's fuel consumption decreases the coupon's discount may decrease.

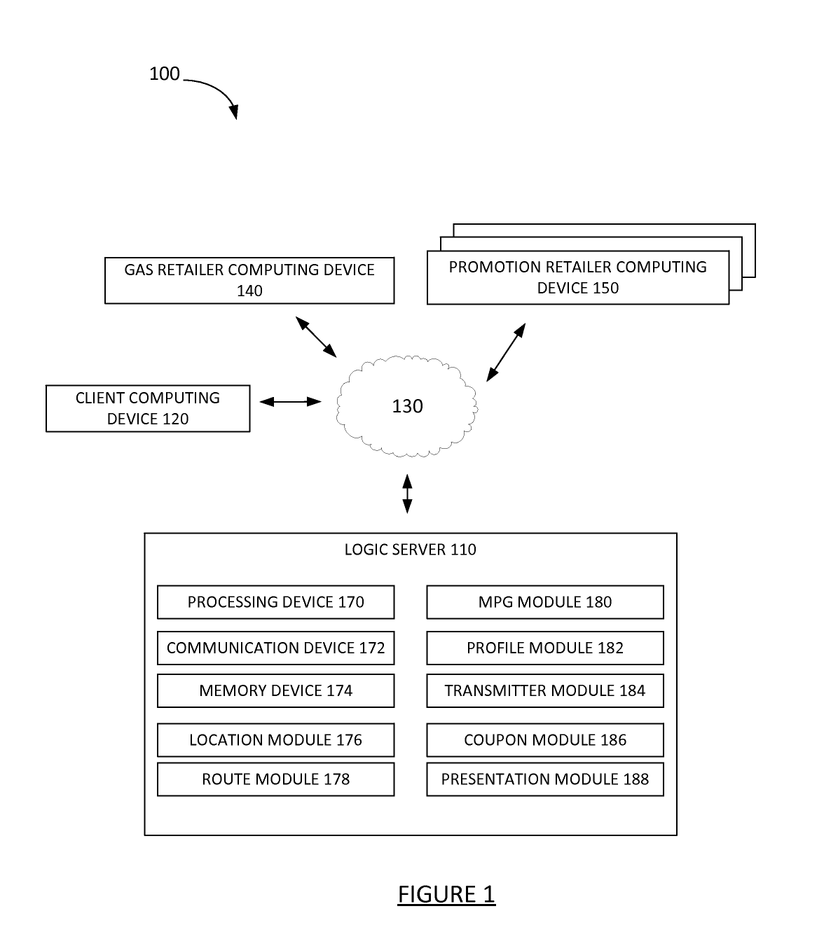

Turning now to FIG. 1, FIG. 1 depicts one topology 100 for attracting consumers to retailers. Topology 100 may include a logic server 110, client computing device 120, a gas retailer computing device 140, and promotion retailer computing device 150. The elements depicted in topology 100 may be communicatively coupled to each other over network 130.

Network 130 may be a wired or wireless network such as the Internet, an intranet, a LAN, a WAN, a NFC network, Bluetooth, infrared, radio frequency, a cellular network or another type of network. It will be understood that network 130 may be a combination of multiple different kinds of wired or wireless networks.

Gas retailer computing device 140 may be a hardware computing device that is associated with a gas retailer, chain of gas retailers, sets of gas retailers that a commonly owned, electric or hybrid vehicle power port, etc. Gas retailer computing device 140 may be configured to allow consumers to redeem fuel consumption based coupons that are transmitted from promotion retailer computing device 150 to client computing device 120. Gas retailer computing device 140 may also be configured to receive reimbursements from logic server 110 responsive to consumers redeeming the fuel consumption based coupons.

Promotion retailer computing device 150 may be a hardware computing device that is associated with promotion retailers, chain of other retailers, sets of retailers, etc. For example, promotion retailers may be salons, restaurants, grocery stores, gas stations, etc. Promotion retailer computing device 150 may be configured to determine coupons for goods and services (referred to hereinafter collectively and individually as “goods”) carried by the promotion retailer, and transmit the determined the coupons to logic server 110. The coupons may include discounts for goods carried by promotion retailer. For example, the coupons may be associated with lunch specials, grocery specials, hair cut specials, etc. In embodiments, the coupons may also include discounts that are based on the consumer's fuel consumption required for the consumer to visit the promotion retailer, wherein the coupons may be activated responsive to a consumer visiting the promotion retailer or purchasing goods associated with the promotion retailer.

Furthermore, once activated, the fuel consumption based discount may be redeemed at a gas retailer associated with gas retailer computing device 140. Thus, the coupon may include a consumption based reimbursement to reimburse the consumer for an amount of fuel used by the consumer to visit the promotion retailer. More specifically, the promotion within a coupon may be based on a consumer's location, the retailer's location, traffic data, vehicle data (e.g. a vehicle's highway miles per gallon, city miles per gallon, etc.), time stamps associated with the coupons, weather conditions affecting fuel consumption, and/or the consumer's driving habits, wherein the consumer's driving habits may include attributes that may vary the fuel consumption used and routes that the consumer takes.

Logic server 110 may be a computing device, such as a general hardware platform server configured to support mobile applications, software, and the like executed on client computing device 120, gas retailer computing device 140, and/or promotion retailer computing device 150. Logic server 110 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Logic server 110 may include any combination of one or more computer-usable or computer-readable media. For example, Logic server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Logic server 110 may be configured to receive coupons from retailer computing device 150, and logic server 110 may be configured to transmit coupons to client computing device 120. Logic server 110 may include a processing device 170, a communication device 172, a memory device 174, a location module 176, a route module 178, a MPG module 180, a profile module 182, a transmitter module 184, coupon module 186, and a presentation module 188.

Processing device 170 may include memory, e.g., read only memory (ROM) and random access memory (RAM), storing processor-executable instructions and one or more processors that execute the processor-executable instructions. In embodiments where processing device 170 includes two or more processors, the processors may operate in a parallel or distributed manner. Processing device 170 may execute an operating system of logic server 110 or software associated with other elements of logic server 110.

Communication device 172 may be a device that allows logic server 110 to communicate with another device over a wireless or wired network over network 130. Communication device 172 may include one or more wireless transceivers for performing wireless communication and/or one or more communication ports for performing wired communication. Communication device 172 may be configured to communicate data over a plurality of different standard and/or protocols.

Memory device 174 may be a device that stores data generated or received by logic server 110. Memory device 174 may include, but is not limited to a hard disc drive, an optical disc drive, and/or a flash memory drive. In embodiments, memory device 174 may be configured to store information received from client computing device 120, gas retailer computing device 140, and/or promotion retailer computing device 150. The information stored within memory device 174 may be accessed by processing device 170, communication device 172, and/or modules 176, 178, 180, 182, 184, 186, 188.

Location module 176 may be a hardware processing device configured to determine the location of a gas retailer, promotion retailer and/or client computing device 120 associated with a consumer. A location may be represented in geographic coordinates, Cartesian coordinates, e.g., an (x, y) point on a map if the map is divided into a Cartesian plane, and/or may be represented using reference points. In embodiments, location module 176 may determine the location of a promotion retailer responsive to an employee associated with the promotion retailer performing actions to enter location information for the promotion retailer. The location information may be subsequently transmitted to logic server 110. Responsive to receiving the location information associated with the promotion retailer, location module 176 may store the location information within a corresponding entry for the promotion retailer within a database within memory device 174.

Location module 176 may be configured to determine the location of client computing device 120 and/or corresponding vehicle responsive to receiving location information from client computing device 120 or responsive to transmitting requests for location information to client computing device 120. In embodiments, location module 176 may be configured to receive the location information of client computing device 120 at set intervals, which may be any desired period of time (e.g., every 1/10^{th} of a promotion, every promotion, every minute, every ten minutes, etc.), based on the consumer's settings within the consumer's profile, or responsive to the consumer performing actions on client computing device 120. Location module 176 may determine the location of client computing device 120 via any known means, such as a RTLS WiFi, proximity becons, radar, mobile device tracking, time distance of arrival (TDOA) signals, short wave radio, Bluetooth, etc. Responsive to determining the location of client computing device 120, location module 176 may store, within a corresponding entry of database within memory device 176. The location information may include a time stamp identifying the time that the location of the vehicle is determined. In embodiments, responsive to location module 176 determining that client computing device 120 is located at or in close proximity to a retailer, location module 176 may transmit a notification to gas retailer computing device 140 or promotion retailer computing device 150 indicating that client computing device 120 is in close proximity to the retailer.

Route module 178 may be a hardware processing device configured to determine navigation routes from a consumer's location to a promotion retailer associated with a coupon. In embodiments, the locations of the consumer and promotion retailers may be determined by location module 176. The route determined by route module 178 may be comprised of vectors (e.g., a start point, an end point, a direction for a road, a length of road, a type of a road) with each route being comprised of possible hundreds of sections of roads, wherein each road may be defined by a start point, an end point, and have a road type. Utilizing the vectors, route module 178 may be configured to determine the distance between the consumer and the promotion retailer. Route module 178 may also be configured to be a navigation device that may provide driving instructions using a combination of text, symbols, voice guidance, and a moving map. Route module 178 may calculate a route between the consumer and the promotion retailer as applied to the map information stored within memory device 174, all major actions (e.g. turning corners, crossroads, roundabouts, etc.) that are schematically depicts by arrows or other indicated overlaid on the route. The route may also include an action indicator showing the distance to the next actions, the name of the current road, an estimated time before arriving at the retailer, etc.

MPG module 180 may be a hardware processing device configured to determine an amount of fuel or energy (referred to hereinafter collectively and individually as “fuel”) required for the consumer to visit the promotion retailer to redeem a coupon. The amount of fuel required for the consumer to visit the promotion retailer may be determined when the coupon is transmitted to client computing device 120. The amount of fuel may be determined utilizing the location of client computing device 120 and the promotion retailer's location. In embodiments, the amount of fuel required for the consumer to visit the promotion retailer may be based on vehicle metrics associated with a vehicle operated by the consumer (e.g. highway miles per gallon, street miles per gallon, etc.), a distance between the consumer and the promotion retailer (e.g. one mile, five miles, etc.), the type of roads between the consumer and promotion retailer (e.g. highway, street, etc.), traffic conditions, weather conditions, and/or a driving profile of the consumer, wherein the average amount of fuel for different consumers may vary on the same route based on how consumers drive (e.g., speeding, hard breaking, etc.). In embodiments, MPG module 180 may be configured to determine the amount of fuel required for the consumer to visit the promotion to redeem the coupon, responsive to the user performing actions on a graphical user interface of client computing device 120 accepting the coupon. Once the user performing actions on the graphical user interface, multiple promotion retailers may add offerings, coupons, promotions to be displayed to the user, wherein the user may opt to visit the promotion retailers in a single visit and the fuel consumption discounts, fuel rewards, coupons, etc. may be aggregated together. For hybrid or electric vehicles, MPG module 180 may be configured to determine an amount of energy utilized by a vehicle to move from a current location to a promotion retailer. The promotions may be aggregated but rewarded separately upon making a purchase from promotion retailer. All the above action could be completed automatically without user action. Furthermore, this offer could be provided by multiple retailers when the user is at one of the promotion retailer, such as a mall.

In addition, the user may have not performed a search and the may already be located at the promotion retailer location or at the mall. The promotion retailer may offer user mileage based rewards based on the user's driving from a previous location to the promotion retailer without the user's knowledge or interaction. The tracking of vehicle movement or accelerometer via a client computing device may automatically track a vehicle in motion and miles driven. The promotion retailer may also prefer to give approximate rewards based on miles, such as one mile, two miles, five miles, etc.

Profile module 182 may be a hardware processing device configured to create a profile for the consumer. The consumer's profiles may include user information, vehicle information, route information, and the consumer's purchasing history.

The user information may include for example, information identifying users (e.g., a username or handle, a number, an identifier, and/or other identifying information), security login information (e.g., a login code or password), payment information (e.g., credit card information), loyalty rewards cards, demographic information associated with users, driving style information associated with the user, or any other information associated with the user. The vehicle information may include information corresponding to the vehicle, such as the vehicle's make or model, the vehicle's average mileage on a highway or standard road, a vehicle's maximum capacity for fuel, etc. The route information may include information corresponding to a user's favorite points of interests, retailers, frequent routes taken, etc.

The purchasing history may include information associated with a consumer's shopping habits, which may be utilized to determine when a consumer may desire to receive a coupon associated with a promotion retailer's goods. The consumer information may be a collection of purchases, including each product purchased, categories of products purchased, when and at what price each product is purchased and from what retailer, what other products are purchased at the same time (e.g. from the same retailer on the same day). This collection may be aggregated to determine a purchase history of the retailer. In embodiments, the purchasing history may be utilized by the promotion retailer and/or the gas retailer to transmit targeted promotions to the consumers.

Transmitter module 184 may be a hardware processing device configured to determine when to transmit coupons to the consumer. Transmitter module 184 may be configured to transmit the coupons based on consumer based triggers or thresholds, default thresholds, and/or the consumer's purchasing history. For example, transmitter module 184 may be configured to transmit coupons based on a purchase history of the consumer, a time and/or date, which may associated with a timing that the consumer desires to purchase the same or similar item. Responsive to determining that the consumer may desire to purchase a good at a specific date or time, transmitter module 184 may transmit coupons from retailers that have promotions associated with the good that the consumer is likely to purchase. The consumer may also set triggers and thresholds associated with when the consumer may desire to receive coupons. The triggers and/or thresholds may be entered by the consumer on client computing device 120. Non-limiting examples of thresholds and triggers may include triggers associated with when to transmit coupons to the consumer. The triggers may be associated with the consumers purchasing patterns (e.g. buys milk on Mondays), a retailer that the consumer always desires to receive coupons from, a category of product that the consumer always desires to receive coupons for, a fuel consumer threshold between the consumer and a retailers (e.g. if the consumer is within ten miles from a specific retailer, and the specific retailer has a coupon then transmit the coupon), a categories of product trigger (e.g. if retailer restaurant has a lunch special transmit a coupon), a time based trigger (e.g. transmit coupons between 11:00 am and 1:00 pm), a time stamped coupon, or a combination, such as a time based trigger, category based trigger, and fuel consumption trigger (e.g., if a restaurant that will only take the consumer one gallon of fuel to travel to has a coupon for lunch between 11:00 and 1:00 pm then transmit the coupon).

Coupon module 186 may be a hardware processing device configured to determine coupons to be transmitted to client computing device 120. The coupons may include a first promotion, a second promotion, and a third promotion. The first promotion may be for being physically located at the promotion retailer, the second promotion may be for purchasing goods at the promotion, retailer, and the third promotion may be a fuel consumption or a distanced based discount that may be redeemed at the gas retailer.

In embodiments, coupon module 186 may determine that the consumer is physically located at the promotion retailer based on the location of the consumer and the location of the promotion retailer. Responsive to the consumer being physically located at the promotion retailer or in close proximity to the promotion retailer, coupon module 186 may transmit data to activate the first promotion. Each of the promotions may be set by the promotion retailer. Therefore, the promotion retailer may set how a discount associated with the gas retailer. Accordingly, the promotion retailer may be able to entice consumers located further away from the promotion retailer to visit the promotion retailer by offering higher discounts at a gas retailer. In embodiments, the fuel consumption or distanced based discount may be fixed, a portion of mile per gallon, vary based on the mileage required (e.g. one cent for the first mile, two cents for the second mile, five cents for the third mile, etc.). Responsive to the consumer redeeming the first, second, or third promotion, coupon module 186 may transmit a notification to logic server 110 that the promotion has been redeemed. The notification may include an identifier associated with the promotion, the amount associated with the promotion, and the purchased goods and/or services. The notification may be utilized by logic server 110 to update the consumer's purchasing history within the consumer's profile. Therefore, the consumer's purchasing history may be updated in real-time to accurately include the goods and/or services purchased. Promotion retailers, gas retailers, credit card companies, banks, etc. may utilize the consumer's purchasing history to transmit relevant promotions with desired discounts to the consumer, wherein the consumer may be more likely to utilize the promotions.

Responsive to the consumer being located at the promotion retailer or purchasing goods offered by the promotion retailer, the third promotion may be activated. When the third promotion is activated, the consumer may use the third promotion to receive a discount, discounts, and/or rewards on fuel or other goods carried by the gas retailer. The third promotion may be a reimbursement made by the promotion retailer to the gas retailer to get users to visit the promotion retailer. Alternatively, the fuel amount may be credited into the users account and redeemed at the fuel retailer. Therefore, the promotion retailer may set the fuel based consumption discounts to be any amount.

In embodiments, the third promotion may include a discount that corresponds to the fuel consumption, distance traveled for the consumer to visit the promotion retailer, and/or the amount of money the user spends at the promotion retailer. For example, the third promotion may be a number of cents off fuel based on the fuel consumed to visit the promotion retailer to be redeemed at the gas retailer if visit the promotion retailer within a given time period, wherein the promotion retailer may set the number of cents off fuel. Because the promotion retailer may set the number of cents off per fuel based on the fuel consumption by the user, the promotion retailer may set a higher number of cents off fuel based on the fuel consumption for users that are closer to the promotion retailer, than users that are further away. Therefore, if a first user travels one mile to visit the promotion retailer, the amount of cents of fuel per fuel consumed to visit the promotion retailer may be higher than a second user that travels fifty miles to visit the promotion retailer.

Furthermore, the third promotion may be based on the amount of money the user spends at the promotion retailer, wherein for every dollar the user spends at the promotion retailer the third promotion may include a number of cents off per gallon of fuel, dollar of fuel, etc. For example, a third promotion may be if the user spends over ten dollars at the promotion retailer the third promotion may be a twenty five cent reimbursement, whereas if the user spends less than ten dollars at the promotion retailer the third promotion may be a fifteen cent reimbursement. Accordingly, the more the user spends at the promotion retailer, the higher the rewards associated with the third promotion.

In embodiments, responsive to the consumer being located at a promotion retailer or purchasing goods carried by the promotion retailer, a loyalty card associated with the consumer may be credited with the first and/or third promotion. Using the loyalty card, the first and/or third promotions may be aggregated, such that the consumer may use a plurality of coupons upon purchasing goods from the gas retailer. Upon the consumer being credited with the first or third promotions or the consumer redeeming the third promotion at a gas retailer, an account associated with the promotion retailer may be deducted a corresponding amount.

In further embodiments, coupon module 186 may be configured to aggregate the third promotions associated with a plurality of promotion retailers that are located in close proximity to one another. For example, if a plurality of promotion retailers are located in a mall, retail center, or otherwise in close proximity to one another, each of the promotion retailers may award an individual third promotion to the user. Responsive to the user being in close proximity to, visiting, and/or purchasing goods or services from the respective promotion retailers, each of the promotion retailers distributes a third promotion to the user. Then, coupon module 186 may be configured to automatically aggregate the mileage base discounts (i.e. third promotions) associated with the different promotion retailers. Additionally, a consumer's promotions associated with the gas retailer may be aggregated over time. Therefore, gas retailers may be able to determine the amount of discounts within a consumer's account, utilize this information to transmit additional, targeted advertisements to the consumer. The targeted advertisements may be time based discounts or rewards for purchasing fuel from a gas retailer, wherein the discounts have a time stamp and a time redemption period.

Presentation module 188 may be a hardware processing device configured to transmit coupons configured to be displayed on a graphical user interface of client computing device 120 associated with the vehicle. The transmitted promotions may include the location of the promotion retailer, the goods and/or services associated with the coupon, the first promotion (e.g. a discounts of goods carried by the promotion retailer, wherein the first promotion may be redeemed at the promotion retailer if the consumer visits the promotion retailer within a given time period), the second promotion (e.g. large pizza for $9.99 at the promotion retailer), and the third promotion for every mile driven to visit the promotion retailer the consumer may deduct 10 cents off fuel at the gas retailer).

Client computing device 120 may be a smart phone, tablet computer, laptop computer, a computer embedded within a vehicle, a computer coupled to a vehicle's processor and/or the vehicle's sensors, personal data assistant, or any other type of mobile device with a hardware processor that is configured to process instructions and connect to one or more portions of network 130. For example, client computing device 120 may be an embedded processing device positioned within a vehicle, such as a car, motorcycle, boat, driverless vehicle, hybrid vehicle, etc. Client computing device 120 may be configured to determine the location of client computing device 120 and be configured to receive inputs from the consumer's, such as the profile information, purchasing history, triggers, and thresholds. Client computing device 120 may be further configured to transmit the determined location of client computing device 120 and the profile information, purchasing history, triggers, and thresholds to logic server 110.

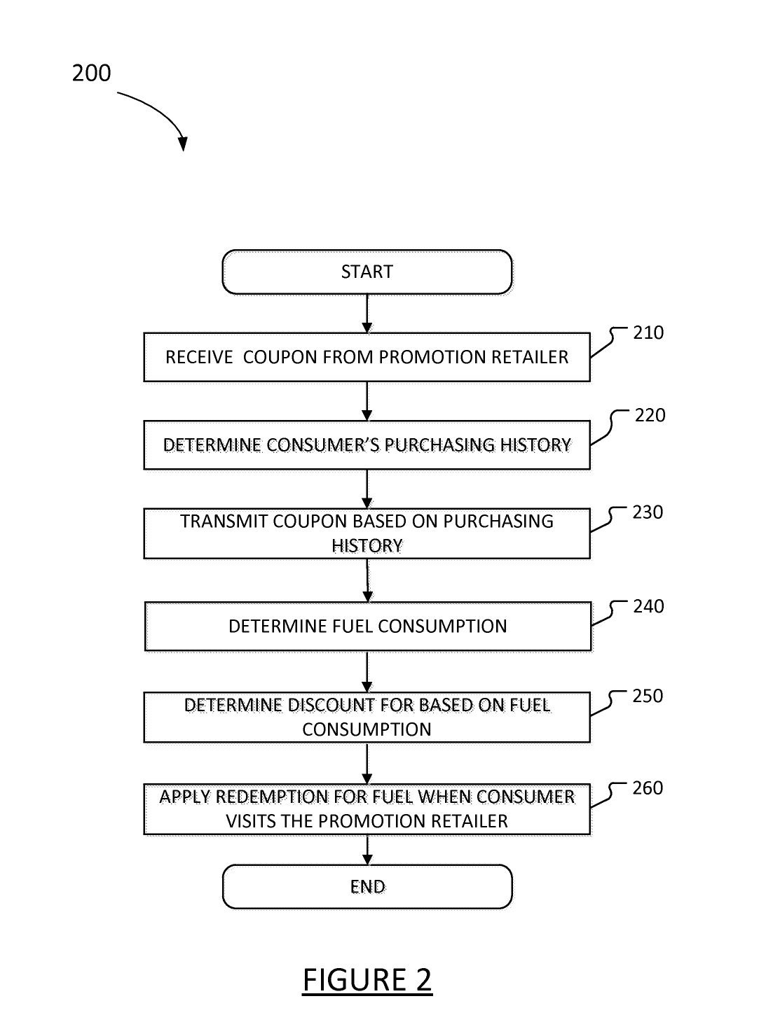

FIG. 2 illustrates a method 200 for transmitting coupons with a promotion based on fuel consumption. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At operation 210, a coupon may be received from a promotion retailer. The coupon may include a discount for goods carried by the promotion retailer and a fuel consumption based discount, wherein the location based coupon may be redeemed at the promotion retailer and the fuel consumption based discount may be redeemed at a gas retailer. The fuel consumption based discount may be associated with an amount of fuel it would take for a consumer to visit the promotion retailer. The fuel consumption based discount may be activated responsive to a consumer purchasing a good from a promotion retailer. The promotion may include the discount for fuel responsive to the consumer being physically located at the promotion retailer even if the consumer does not purchase any goods. However, the discount for fuel for being physically located at the promotion retailer may be less than the fuel consumption based discount. Operation 210 may be performed by a communication device that is the same as or similar to communication device 172, in accordance with one or more implementations.

At operation 220, a consumer's purchasing history may be determined. The consumer purchasing information may be a collection of purchases, including each product purchased by the consumer, categories of products purchased by the consumer, when and at what price each product was purchased, from what retailer were goods purchased by the consumer, each product purchased by the consumer, what other products are purchased at the same time (e.g. from the same retailer on the same day), etc. This collection may be aggregated to determine a purchase history of the consumer at the retailer, which may be utilized to determine when the consumer will desire to purchase the same item or a similar item. For example, if it is determined that the consumer purchases lunch at different restaurants around 12:00 pm each weekday, the purchasing history of the consumer may determine that on a weekday the consumer will purchase lunch at a restaurant around 12:00 PM on a weekday. Operation 220 may be performed by a profile module that is the same as or similar to profile module 182, in accordance with one or more implementations.

At operation 230, responsive to determining that the consumer is likely to buy a product or a similar product based on the consumers purchasing history, a coupon including the promotions may be transmitted. The coupons may be presented as a discount off fuel based on the how much fuel the consumer would use to visit the promotion retailer (e.g. the consumer will receive five cents off for every mile the amount of fuel it would take to visit the promotion retailer). In further implementations, other triggers may be utilized to transmit the coupon. Operation 230 may be performed by a communication device that is the same as or similar to communication device 172, in accordance with one or more implementations.

At operation 240, responsive to transmitting the coupon, an amount of fuel required for the consumer to visit the promotion retailer from the consumer's location when the coupon is transmitted may be determined. The amount of fuel required for the consumer to visit the promotion retailer may be based on vehicle metrics associated with a vehicle operated by the consumer (e.g. highway miles per gallon, street miles per gallon, etc.), a distance between the consumer and the promotion retailer (e.g. one mile, five miles, etc.), the type of roads between the consumer and promotion retailer (e.g. highway, street, etc.), traffic conditions, weather conditions, and/or a driving profile of the consumer, wherein the average amount of fuel for different consumers may vary for the same route based on how consumers drive (e.g., speeding, hard breaking, etc.). Operation 240 may be performed by a MPG module that is the same as or similar to MPG module 180, in accordance with one or more implementations.

At operation 250, the discount for the fuel consumption based promotion may be determined based on the fuel consumption required for the consumer to visit the promotion retailer. For example, if the promotion indicates that the consumer may receive two cents off the price of fuel for each gallon that the consumer expends to visit the promotion retailer and the consumer expends five gallons of fuel to visit the promotion retailer, then the discount may be for ten cents off a price of fuel which may be redeemed at a gas retailer. Operation 250 may be performed by a coupon module that is the same as or similar to coupon module 186, in accordance with one or more implementations.

At operation 260, responsive to the consumer visiting the promotion retailer and purchasing a good associated with the transmitted coupon, the fuel consumption based coupon may be activated for use by the consumer. Thus, the consumer may visit the gas retailer to receive a fuel discount. In embodiments, the fuel discount may be activated via the coupon, a promo code, egift card, or coupon may be transmitted to the user, or the fuel discount may be accumulated with a loyalty card associated with the gas retailer. Operation 260 may be performed by a coupon module that is the same as or similar to coupon module 186, in accordance with one or more implementations.

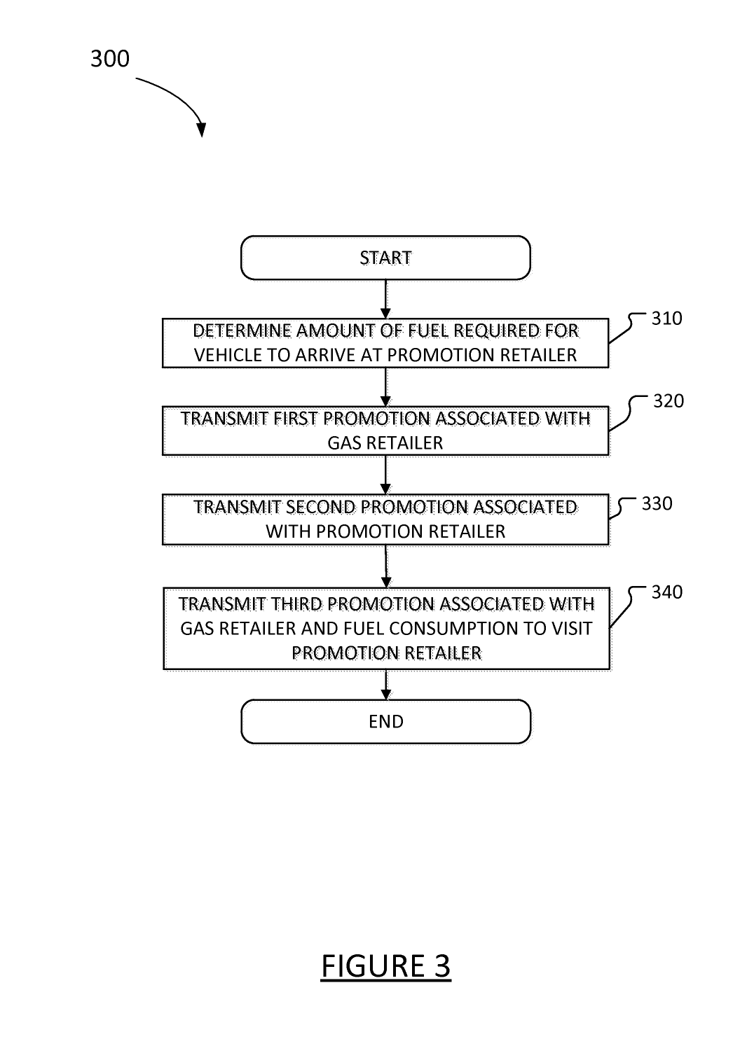

FIG. 3 illustrates a method 300 for transmitting coupons with a promotion based on fuel consumption. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At operation 310, an amount of fuel required for a vehicle to arrive at a promotion retailer may be determined. The amount of fuel required may be determined based on a plurality of factors including the location of the vehicle, the location of the gas retailer, vehicle type, types of road segments between the location of the vehicle and the location of the gas retailer, etc. Operation 310 may be performed by a MPG module that is the same as or similar to MPG module 180, in accordance with one or more implementations.

At operation 320, a first promotion may be transmitted. The first promotion may be associated with a promotion retailer, wherein the first promotion may be activated or redeemed after the consumer is located at the promotion retailer. For example, the first promotion may be a discount goods carried by the promotion retailer, which is offered to the consumer when the consumer visits the promotion retailer. Operation 320 may be performed by a coupon module that is the same as or similar to coupon module 320, in accordance with one or more implementations.

At operation 330, a second promotion may be transmitted. The second promotion may be associated with goods and/or services at the promotion retailer. The second promotion may be transmitted to the consumer responsive to the vehicle being located at the promotion retailer, in advance to the consumer arriving at the promotion retailer, or in response to determining the amount of fuel required for the consumer to arrive at the promotion retailer. The second promotion may be based on a user's purchasing history, wherein the second promotion may include a discount of goods and/or services purchased previously at the promotion retailer. Operation 330 may be performed by a coupon module that is the same as or similar to coupon module 320, in accordance with one or more implementations.

At operation 340, a third promotion may be transmitted. The third promotion may be a mileage based coupon to be redeemed at the gas retailer. The amount within the third promotion may be based on the amount of fuel that the vehicle will consume driving to the promotion retailer, a round trip visit by the user, or any other desired mileage based discount. Operation 340 may be performed by a coupon module that is the same as or similar to coupon module 320, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A consumption based discount system comprising:
a location module configured to determine a location of a user and a promotion retailer;
a mile per gallon module configured to determine an amount of fuel required for the user to visit the promotion retailer;
a coupon module configured to transmit a promotion retailer coupon and a gas retailer coupon, wherein the promotion retailer coupon is associated with a discount at the promotion retailer and the gas retailer coupon is a fuel consumption based discount associated with the amount of fuel required for the user to visit the promotion retailer.

2. The system of claim 1, wherein the gas retailer coupon is activated in response to using the promotion retailer coupon.

3. The system of claim 1, wherein the fuel consumption based discount is a number of cents off fuel at the gas retailer based on a number gallons used to visit the promotion retailer.

4. The system of claim 3, wherein the promotion retailer determines the number of cents off fuel at the gas retailer per gallon of fuel used to visit the promotion retailer.

5. The system of claim 1 wherein the gas retailer coupon may be based on an amount of money spent at the promotion retailer.

6. The system of claim 1, wherein the coupon module is configured to transmit a plurality of promotion retailer coupons, and the gas retailer coupon may be based on an aggregate fuel consumed to visit the plurality of promotion retailers, wherein the amount of fuel required for the user to visit each of the promotion retailers is independently accounted for.

7. The system of claim 1, wherein the coupon module is configured to transmit a location based coupon, wherein the location based coupon is associated with a fuel discount at the gas retailer that is activated responsive to the user being located at the promotion retailer.

8. The system of claim 1, wherein the amount of fuel required for the user to visit the promotion retailer may be based on at least a driving distance, a road type, and a vehicle type.

9. The system of claim 1, wherein the gas retailer coupon is activated responsive to a number of independent users using promotion retailer coupons associated with the promotion retailer.

10. The system of claim 1, wherein the promotion retailer reimburses the gas retailer for the fuel consumption based discount.

11. A consumption based discount method comprising:
determine a location of a user;
determining a location of a promotion retailer;
determine an amount of fuel required for the user to visit the promotion retailer
transmitting a promotion retailer coupon that is associated with a discount at the promotion retailer; and
transmitting a gas retailer coupon that is a fuel consumption based coupon associated with the amount of fuel required for the user to visit the promotion retailer.

12. The method of claim 11, further comprising:
activing the gas retailer coupon in response to using the promotion retailer coupon.

13. The method of claim 11, wherein the fuel consumption based discount is a number of cents off fuel at the gas retailer based on a number of gallons of fuel used to visit the promotion retailer.

14. The method of claim 13, further comprising:
determining, by the promotion retailer, the number of cents off fuel at the gas retailer per gallon of fuel used to visit the promotion retailer.

15. The method of claim 11 wherein the gas retailer coupon may be based on an amount of money spent at the promotion retailer.

16. The method of claim 11, further comprising:
transmitting a plurality of promotion retailer coupons to the user;
aggregating the fuel consumed to visit the plurality of promotion retailers, wherein the amount of fuel required for the user to visit each of the promotion retailers is independently accounted for; and
determining the gas retailer coupon based on the aggregation of the fuel consumed to visit the plurality of promotion retailers.

17. The method of claim 11, further comprising:
transmitting a location based coupon, wherein the location based coupon is associated with a fuel discount at the gas retailer that is activated responsive to the user being located at the promotion retailer.

18. The method of claim 11, wherein the amount of fuel required for the user to visit the promotion retailer may be based on at least a driving distance, a road type, and a vehicle type.

19. The method of claim 11, further comprising:
activing the gas retailer coupon responsive to a number of independent users using promotion retailer coupons associated with the promotion retailer.

20. The method of claim 11, further comprising:
reimbursing the gas retailer by the promotion retailer for the fuel consumption based discount.
